(19) United States
(12) Patent Application Publication
(10) Pub. No.: US 2025/0252533 A1
(43) Pub. Date: Aug. 7, 2025

(54) WAVELET-BASED AUTOENCODERS FOR LATENT DIFFUSION MODELS

(71) Applicants: Disney Enterprises, Inc., Burbank, CA (US); ETH Zürich (Eidgenössische Technische Hochschule Zürich),, Zurich (CH)

(72) Inventors: Seyedmorteza SADAT, Zurich (CH); Jakob Joachim BUHMANN, Zurich (CH); Romann Matthew WEBER, Zurich (CH); Derek Edward BRADLEY, Zurich (CH)

(21) Appl. No.: 19/042,132

(22) Filed: Jan. 31, 2025

Related U.S. Application Data
(60) Provisional application No. 63/627,943, filed on Feb. 1, 2024.

(51) Int. Cl. G06T 5/10; G06V 10/44; G06V 10/52; G06V 10/80

(52) U.S. Cl. CPC G06T 5/10; G06V 10/44; G06V 10/52; G06V 10/806; G06T 2207/20064; G06T 2207/20081

(57) ABSTRACT

The computational requirements of an encoder of an autoencoder can be reduced by pre-processing the images using a discrete wavelet transform (DWT). In one embodiment, the encoder uses a multi-level DWT to extract multiscale information from the input images. If using a learned encoder, performing the multi-level DWT enables the encoder to have less complex feature extraction and aggregation networks (e.g., convolution neural networks (CNNs)) than a standard encoder for an autoencoder. This means the VAE can execute faster, use less computational resources (such as GPU memory), and use less power than traditional VAEs. If using a non-learned encoder, the result of the multi-level DWT can be used as the latent code without using feature extraction and aggregation networks.

### CROSS-REFERENCE TO RELATED APPLICATIONS

This application claims priority to U.S. Provisional Patent Application No. 63/627,943, filed Feb. 1, 2024, the entire content of which is incorporated herein by reference in its entirety.

### BACKGROUND

Autoencoders are a type of neural network primarily designed to compress input data into a lower-dimensional representation (latent space) and then reconstruct the original data from that compressed version, extracting key features from the data while learning important patterns within it. Autoencoders are commonly used for tasks like dimensionality reduction, data denoising, anomaly detection, and feature extraction in images and other data types.

Autoencoders are often used with latent diffusion models (LDMs) which are a type of generative artificial intelligence (AI) model used primarily for image synthesis. LDMs have assumed dominance in the field of high-resolution image generation, primarily due to their scalability and training stability over pixel-space diffusion.

### SUMMARY

One embodiment described herein is a method that includes transforming an input image into a latent code using an encoder of an autoencoder by performing a multi-level discrete wavelet transform (DWT) on the input image; generating, based on the latent code, a reconstructed latent code using a LDM; and training the LDM using a denoising loss based on comparing the reconstructed latent code and the latent code.

Another embodiment described herein is a non-transitory computer readable medium containing computer program code that, when executed by operation of one or more computer processors performs operations. The operations includes transforming an input image into a latent code using an encoder of an autoencoder by performing a multi-level DWT on the input image; generating, based on the latent code, a reconstructed latent code using a LDM; and training the LDM using a denoising loss based on comparing the reconstructed latent code and the latent code.

Another embodiment described herein is a system that includes a processor and a memory having instructions stored thereon which, when executed on the processor, performs operations. The operations include transforming an input image into a latent code using an encoder of an autoencoder by performing a multi-level DWT on the input image; generating, based on the latent code, a reconstructed latent code using a LDM; and training the LDM using a denoising loss based on comparing the reconstructed latent code and the latent code.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 illustrates a system for training an autoencoder, according to one embodiment.

FIGS. 2A and 2B illustrate systems for training a LDM, according to embodiments.

FIG. 3 illustrates a system for performing inference using a trained LDM, according to one embodiment.

FIG. 4 illustrates an autoencoder that uses a discrete wavelet transform, according to one embodiment.

FIG. 5 illustrates a networks for implementing feature extraction and aggregation, according to one embodiment.

FIG. 6 illustrates a computing system for training a LDM, according to one embodiment.

FIG. 7 is a flowchart for training a LDM, according to one embodiment.

### DETAILED DESCRIPTION

Training an LDMs involves two separate stages. In the first stage, a variational autoencoder (VAE) is trained to transform the raw pixels of an image into a more compact latent representation (referred to as latent codes). In the second stage, the LDM is trained on the latent codes—i.e., the latent representations of training images. The VAE in LDMs is not only computationally demanding to train but also affects the efficiency of the LDM training phase due to the resource requirements of querying a large encoder network for computing the latent codes.

The embodiments herein can reduce the computational requirements of the VAE by pre-processing training images using a discrete wavelet transform (DWT). In one embodiment, the encoder of the VAE uses a multi-level DWT to extract multiscale information from the input images. Doing so enables the encoder to have less complex feature extraction and aggregation networks (e.g., convolution neural networks (CNNs)) than an encoder in a standard VAE. Put differently, to achieve the same results as a typical VAE, a VAE that uses DWT preprocessing can have much smaller/less complex extraction networks. This means the encoder portion of the VAE can execute faster and use less power than traditional VAEs. Moreover, the VAE can have less memory requirements than traditional VEAs, which is often the biggest computational bottleneck for training these typically large models.

For example, because traditional VAEs are computationally demanding, a possible workaround for this resource burden is to precompute and cache the latent codes for the entire dataset to avoid having to use the autoencoder during LDM training. That is, the VAE is first used to compute the latent codes for the images, cached in memory, and then these codes are later used to train the LDM. However, in addition to its initial overhead of having to store each latent code in memory, this approach eliminates the possibility of using on-the-fly techniques, such as data augmentation, which have been shown to improve the training and performance of LDMs (or diffusion models more generally). Instead, when using embodiments of a VAE described herein, autoencoding can occur in parallel with LDM training since it is very fast, which means caching can be avoided and data augmentation can be performed.

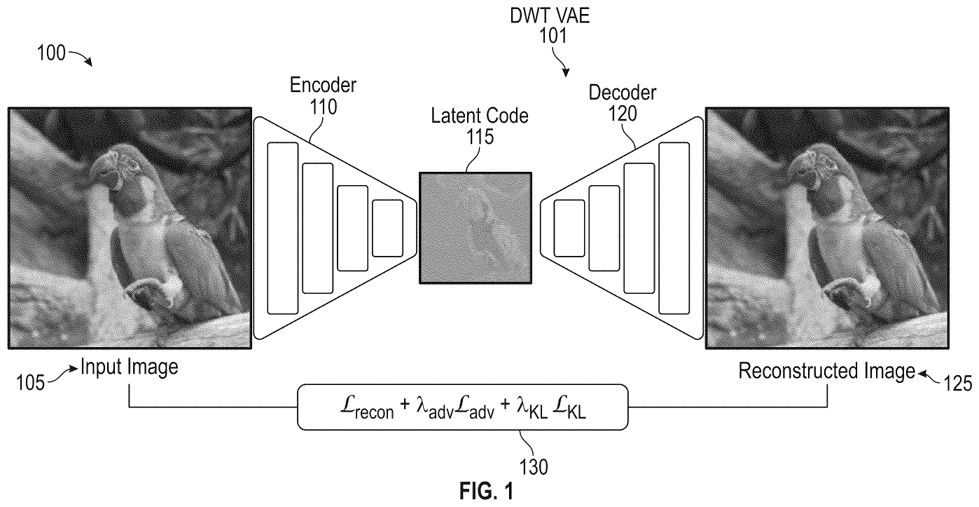

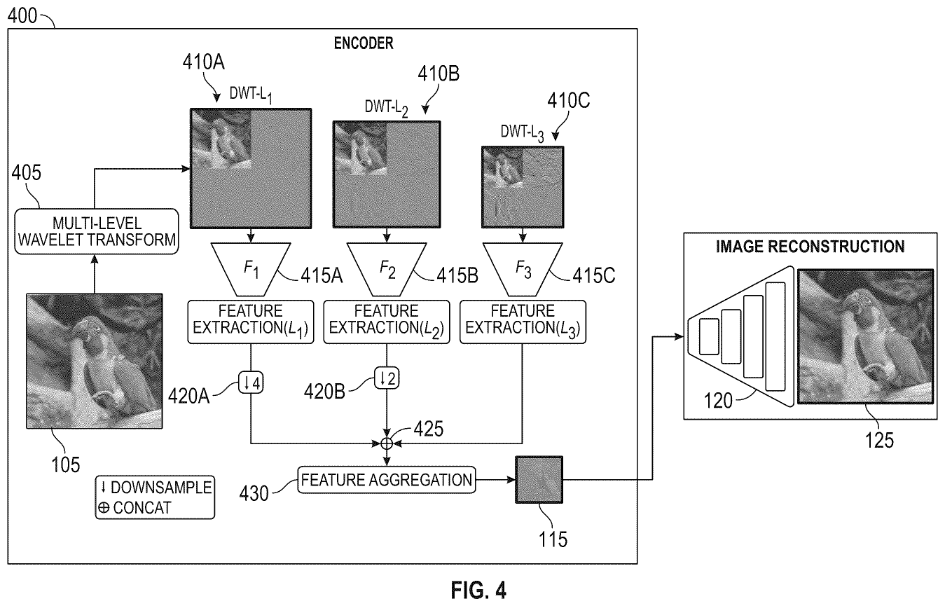

FIG. 1 illustrates a system 100 for training an autoencoder, according to one embodiment. FIG. 1 illustrates inputting an input image 105 into a DWT VAE 101 (i.e., a VAE that performs pre-processing on the input image 105 using a DWT) which includes an encoder 110 and a decoder 120. In one embodiment, the encoder 110 of the VAE 101 performs a multi-level DWT on the input image 105, where the results of each level are passed to different feature extraction networks (e.g., CNNs) to perform feature extraction. These features can then be aggregated to output a latent code 115. The details of this type of learned DWT VAE 101 with a learned encoder 110 will be discussed in FIG. 4.

However, the embodiments herein can also be used with a non-learned VAE with a non-learned encoder. In a non-learned encoder, the result of performing multi-leveling DWT can be used as the latent code 115. Stated differently, in a non-learned VAE, the encoder 110 of the VAE 101 may not include feature extraction networks. Also, since a non-learned VAE 101 does not have learning networks (e.g., the feature extraction and aggregation CNNs), it would not be trained, unlike learned VAE 101 where training is typically performed.

A non-learned VAE 101 may have several advantages over a learned VAE 101, such as being to execute slightly faster (since the feature extraction and aggregation networks are omitted) and skipping the training of the encoder 110 of the VAE training phase (although the decoder 120 may still be trained). However, the non-learned VAE 101 may result in poorer results when used to train a LDM, which can ultimately result in poorer performing LDMs. However, non-learned VAEs 101 may be preferred in compute constrained environments, or when the tasks performed by the LDM accept lower quality image generation.

The latent code 115 represents the input image 105 in latent space. As mentioned above, the latent code/space is a compressed version of the input image 105.

When visualizing the latent code 115 learned by a Stable Diffusion VAE (SD-VAE), the code is itself image-like, with a strong similarity to the input. As such, the learning of these latent representations can be simplified by applying a fast image-processing function to the input images prior to encoding. As described herein, DWT is used as the image-processing function due to its image-like structure, proven effectiveness in extracting rich, compact features from images, and wide applicability in image-processing tasks such as image compression.

The decoder 120 of the VAE 101 is then used to transform the latent code 115 into a reconstructed image 125. That is, the decoder 120 transforms the latent code 115 from latent space back into image space. In one embodiment, the decoder is a fully convolutional network similar to that in a Stable Diffusion VAE.

The system 100 then calculates a reconstruction loss 130 between the input image 105 and the reconstructed image 125. This reconstruction loss 130 is then used to train the convolution networks in the encoder 110 and the decoder 120. That is, the reconstruction loss 130 is used to update the parameters (e.g., weights, etc.) in the learning networks in the encoder 110 and the decoder 120. This process can then repeat using a new input image 105 until eventually the encoder 110 and the decoder 120 have been trained. This is the first stage of training a LDM.

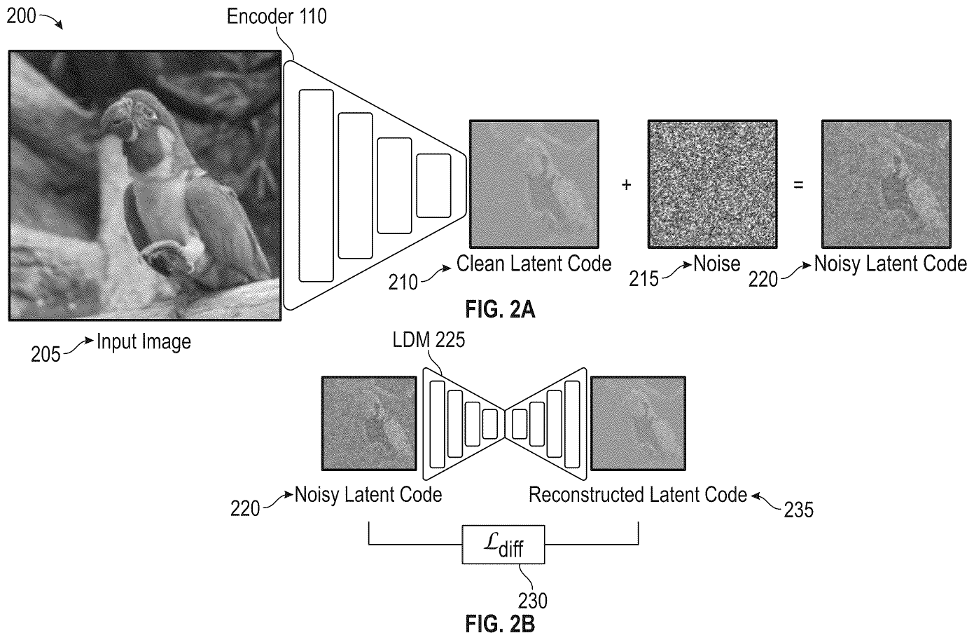

FIGS. 2A and 2B illustrate systems for training a LDM, according to embodiments. That is, FIGS. 2A and 2B illustrate a second stage of training a LDM (which is broken up into two sub-steps). FIG. 2A illustrates using the now trained encoder 110 to transform the input image 205 into a clean latent code 210. That is, the encoder 110 may perform the same process and system as described in FIG. 1 to generate the latent code 115. The system 200 then combines the clean latent code 210 with noise 215 (e.g., Gaussian noise) to generate a noisy latent code 220.

FIG. 2B illustrates inputting the noisy latent code 220 generated in FIG. 2A into a LDM 225, which attempts to remove the noise from the noisy latent code to generate the reconstructed latent code 235. That is, the LDM 225 attempts to reconstruct the clean latent code 210 in FIG. 2A from the noisy latent code 220.

The system 200 then calculates a denoising loss 230 between the clean latent code 210 and the reconstructed latent code 235. The denoising loss 230 is then used to train the networks in the LDM 225. That is, the denoising loss 230 is used to update the parameters (e.g., weights, etc.) in the LDM 225. The process illustrated in FIGS. 2A and 2B can then repeat using a new input image 205 until eventually the LDM 225 has been trained.

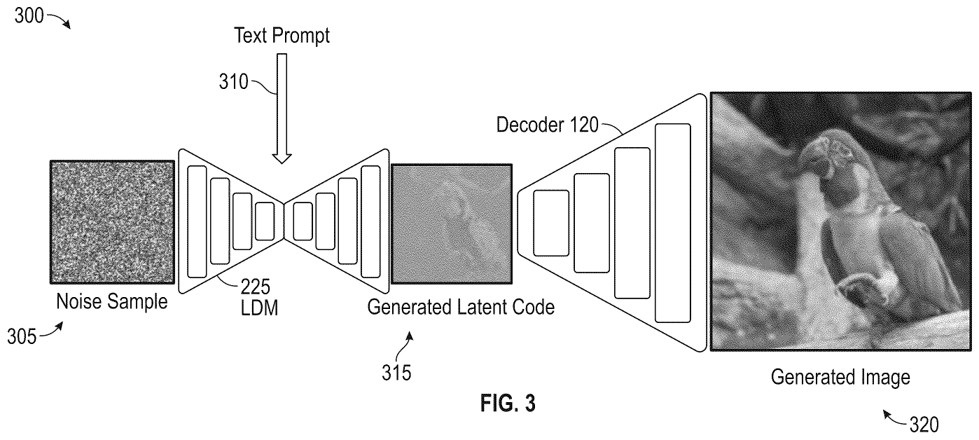

FIG. 3 illustrates a system 300 for performing inference using the trained LDM 225, according to one embodiment. That is, the inference operation illustrated in FIG. 3 may be performed after the training stages illustrated in FIGS. 1 and 2 have been performed.

In FIG. 3, a noise sample 305 (e.g., Gaussian noise) is input into the LDM 225 along with a text prompt 310. For example, a user may type the text prompt 310 (or the text prompt 310 may be spoken by a user and then converted into text). For example, the text prompt 310 may be “create an image of a tropical bird with its foot raised.”

The trained LDM 225 determines a condition from the text prompt 310 which the LDM 225 uses to transform the (random) noise sample into a generated latent code 315.

The decoder 120 (which was trained in FIG. 1) can then transform the latent code 315 into a generated image 320. That is, like in FIG. 1, the decoder 120 transforms the latent code 315 from latent space into image space.

Notably, in this embodiment while the decoder 120 from FIG. 1 is used in inference, an encoder portion of the autoencoder (e.g., the encoder 110) is not. Thus, the encoder may be used to train the LDM 225 but is not used during inference. The decoder of the autoencoder is still used during inference.

FIG. 4 illustrates an encoder 400 for an autoencoder (e.g., a VAE) that uses a DWT, according to one embodiment. FIG. 4 illustrates the system 100 in FIG. 1 using a learned encoder 400. That is, FIG. 4 illustrates an architecture for training the encoder 400 and the decoder 120.

As shown, the input image 105 is first pre-processed using a multi-level wavelet transform 405 (e.g., a 2D DWT). During the first level (e.g., a first iteration), the input image is processed by the transform 405 to generate DWT Level 1 (L1) sub-bands 410A. Wavelet transforms are a signal processing technique for extracting spatial-frequency information from input data (i.e., the input image 105). Wavelets are characterized by a low-pass filter L and a high-pass filter H. For 2D signals, four filters are defined via LL^{T}, LH^{T}, HL^{T}, and HH^{T}.

Given an input image x, the 2D wavelet transform 405 decomposes the input image x into a low-frequency sub-band x_{L} and three high-frequency sub-bands {x_{H}, x_{V}, x_{D}} capturing horizontal, vertical, and diagonal details. For an image of size H×W, each wavelet sub-band is of size H/2×W/2. The sub-bands 410A illustrate the sub-bands identified when processing the input image 105 using the wavelet transform 405, where the top left sub-band is the input image downsampled by H/2×W/2 and the top right sub-band, the bottom left sub-band, and the bottom right sub-band represent the horizontal, vertical, and diagonal details of the input image 105. The four sub-bands 410A contain the corresponding wavelet coefficients for L1—i.e., {x_{L}^{I}, x_{H}^{I}, x_{V}^{I}, x_{D}^{I}}.

Multi-resolution analysis is achievable by iteratively applying the wavelet transform to xL at each level. That is, the top left sub-band of the sub-bands 410A is again processed by the wavelet transform 405 to result in the DWT Level 2 (L2) sub-images 410B. Again, the top left sub-band of the sub-bands 410B is the top left sub-band of the sub-band 410A but downsampled by H/4×W/4 while the top right sub-band, while the bottom left sub-band, and the bottom right sub-band of the sub-bands 410B represent the horizontal, vertical, and diagonal details of the top left sub-band of the sub-bands 410A.

FIG. 4 illustrates performing another iteration of multi-resolution analysis by performing the wavelet transform 405 on the top left sub-band of the sub-bands 410B to result in the DWT Level 3 (L3) sub-bands 410C. The top left sub-band of the sub-bands 410C is the top left sub-band of the sub-bands 410B but downsampled by H/8×W/8 while the top right sub-band, while the bottom left sub-band, and the bottom right sub-band of the sub-bands 410C represent the horizontal, vertical, and diagonal details of the top left sub-band of the sub-bands 410B. In this manner, FIG. 4 illustrates iteratively performing the wavelet transform 405 three times on progressively downsampled images. That is, FIG. 4 illustrates achieving an 8× downsampling using three wavelet levels L1, L2, and L3 which extract multiscale information from the input image 105. While three levels are shown, any number of levels could be used, e.g., two, four, five, etc.

Wavelet transforms are also invertible, and one can reconstruct the original image x from the sub-bands {x_{L}, x_{H}, x_{V}, x_{D}} using the inverse wavelet transform. Additionally, the Fast Wavelet Transform (FWT) enables the computation of wavelet sub-bands with linear complexity relative to the number of pixels in the input image x.

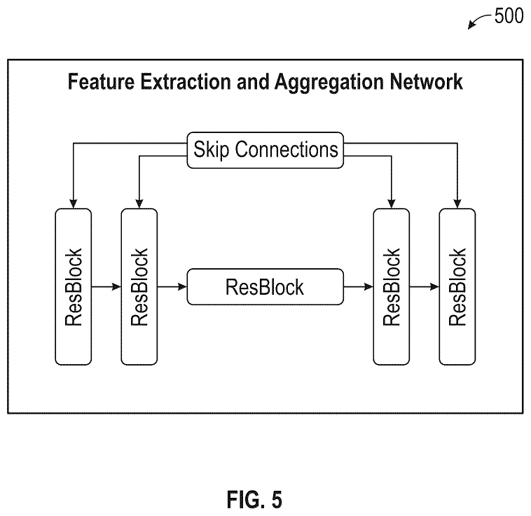

The encoder 400 includes three feature extraction networks 415A-C(labeled F1, F2, and F3) which receive the wavelet coefficients {x_{L}^{I}, x_{H}^{I}, x_{V}^{I}, x_{D}^{I}} of the sub-bands 410A-C. The wavelet coefficients for each of the sub-bands 410 are separately processed by a respective one of the feature extraction networks 415 to compute a multiscale set of feature maps F/({x_{L}^{I}, x_{H}^{I}, x_{V}^{I}, x_{D}^{I}}). The feature extraction networks 415 can include a combination of CNNs. An example implementation of the feature extraction networks 415 will be discussed in FIG. 5 below.

The feature maps for the networks 415A and 415B are then downsampled to match the feature map for the network 415C using the downsamplers 420A and 420B. The feature maps are then combined by a summer 425 and input into a feature aggregation network 430. In one embodiment, the feature aggregation network 430 has a similar or the same architecture as the feature extraction networks 415, and thus, will be described in more detail in FIG. 5. In one embodiment, a UNet-based architecture without spatial down/upsampling layers can be used for feature extraction and aggregation.

The feature aggregation network 430 computes the latent code 115 for the input image 105.

Like in FIG. 1, the decoder 120 can process the latent code 115 and compute the reconstructed image 125. A reconstruction loss (not shown in FIG. 4) can then be used to train the encoder 400 and the decoder 120. In one embodiment, end-to-end training is used to learn the parameters (e.g., weights, etc.) of the feature extraction networks 415, the feature aggregation network 430, and the networks in the decoder 120.

Because the sub-bands 410A-C of the different wavelet levels already contain enough information about the input image 105, lightweight networks can be used for the feature extraction and aggregation networks 415, 430. Hence, the encoder 400 combines the computational benefits of DWT with the expressiveness of a learned autoencoder. As such, the encoder 400 can be as accurate as previous autoencoders but use fewer compute resources and computational time.

Table 1 indicates that the encoder 400 achieves the same reconstruction quality as an encoder in a standard VAE that does not use DWT preprocessing while using 6 times fewer parameters in the encoder 400.

TABLE 1

| | Latent | | | | | |
|---|---|---|---|---|---|---|
| Dataset | Dim | Model | rFID | LPIPS | PSNR | SSIM |
| FFHQ 128 | 16 × 16 × 4 | VAE | 0.88 | 0.089 | 28.08 | 0.85 |
| | | DWT VAE | 0.74 | 0.085 | 28.36 | 0.85 |
| FFHQ 256 | 32 × 32 × 4 | VAE | 0.47 | 0.109 | 2816 | 0.81 |
| | | DWT VAE | .041 | 0.117 | 28.33 | 0.82 |
| ImageNet | 16 × 16 × 4 | VAE | 4.54 | 0.164 | 24.25 | 0.69 |
| 128 | | DWT VAE | 4.40 | 0.164 | 24.49 | 0.71 |
| ImageNet | 32 × 32 × 4 | VAE | 0.89 | 0.160 | 25.83 | 0.73 |
| 256 | | DWT VAE | 0.87 | 0.157 | 26.02 | 0.74 |

Table 2 illustrates that the DWT VAE with the encoder 400 achieves better reconstruction with the same number of parameters as a standard VAE that does not use DWT preprocessing.

| Model | Params (M) | rFID | LPIPS | PSNR | SSIM |
|---|---|---|---|---|---|
| VAE | 34.16 | 0.95 | 0.069 | 29.25 | 0.86 |
| DWT VAE | 32.75 | 0.79 | 0.064 | 29.68 | 0.87 |

Table 3 illustrates the results of training a LDM using a DWT VAE.

| Dataset | Encoder | FID |
|---|---|---|
| FFHQ (256 × 256) | LDM | 8.11 |
| | DWT VAE | 8.03 |
| CelebA-HQ (256 × 256) | LDM | 5.92 |
| | DWT VAE | 5.73 |

FIG. 5 illustrates a network 500 for implementing the feature extraction and aggregation networks discussed in FIG. 4, according to one embodiment. The network 500 includes a plurality of interconnected residual blocks (ResBlocks) and skip connections. The ResBlocks can include a stack of layers such that an output of a layer is added to another layer deeper in the block. The skip connections allow signals to bypass one or more layers in the network 500. As shown here, the skip connections allow some of the ResBlocks to skip the layers contained in other ResBlocks.

FIG. 5 is just one example of CNNs for implementing the feature extraction and aggregation networks discussed in FIG. 4.

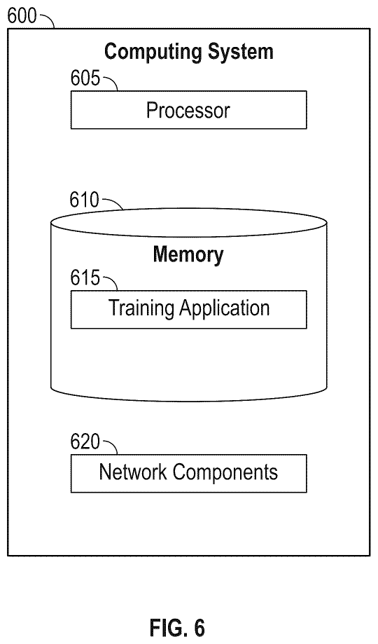

FIG. 6 illustrates a computing system 600 for training a LDM, according to one embodiment. The computing system 600 includes a processor 605, a memory 610, and network components 620. The memory 610 may take the form of any non-transitory computer-readable medium. The processor 605 generally retrieves and executes programming instructions stored in the memory 610. The processor 605 is representative of a single central processing unit (CPU), multiple CPUs, a single CPU having multiple processing cores, graphics processing units (GPUs) having multiple execution paths, and the like.

The network components 620 include the components necessary for the computing system 600 to interface with a suitable communication network. For example, the network components 620 can include wired, WiFi, or cellular network interface components and associated software. Although the memory 610 is shown as a single entity, the memory 610 may include one or more memory devices having blocks of memory associated with physical addresses, such as random access memory (RAM), read only memory (ROM), flash memory, or other types of volatile and/or non-volatile memory.

The memory 610 generally includes program code for performing various functions related to use of the computing system 600. The program code is generally described as various functional “applications” or “modules” within the memory 610, although alternate implementations may have different functions and/or combinations of functions. Within the memory 610, training application 615 trains an LDM. For example, the training application 615 can perform the two stage training process described in FIGS. 1 and 2 using a DWT VAE.

While the computing system 600 is illustrated as a single entity, in an embodiment, the various components can be implemented using any suitable combination of physical compute systems, cloud compute nodes and storage locations, or any other suitable implementation. For example, the computing system 600 could be implemented using a server or cluster of servers. As another example, the computing system 600 can be implemented using a combination of compute nodes and storage locations in a suitable cloud environment. For example, one or more of the components of the computing system 600 can be implemented using a public cloud, a private cloud, a hybrid cloud, or any other suitable implementation. Further, the computing system 600 may include one or more computing platforms, such as computer servers for example, which may be co-located, or may form an interactively linked but distributed system, such as a cloud-based system.

Further, although FIG. 6 depicts the training application 615 as being located in the memory 610 that representation is also merely provided as an illustration for clarity. More generally, the computing system 600 may include one or more computing platforms, such as computer servers for example, which may be co-located, or may form an interactively linked but distributed system, such as a cloud-based system. As a result, the processor 605 and memory 610 may correspond to distributed processor and memory resources. Thus, it is to be understood that the training application 615 may be stored remotely within distributed memory resources.

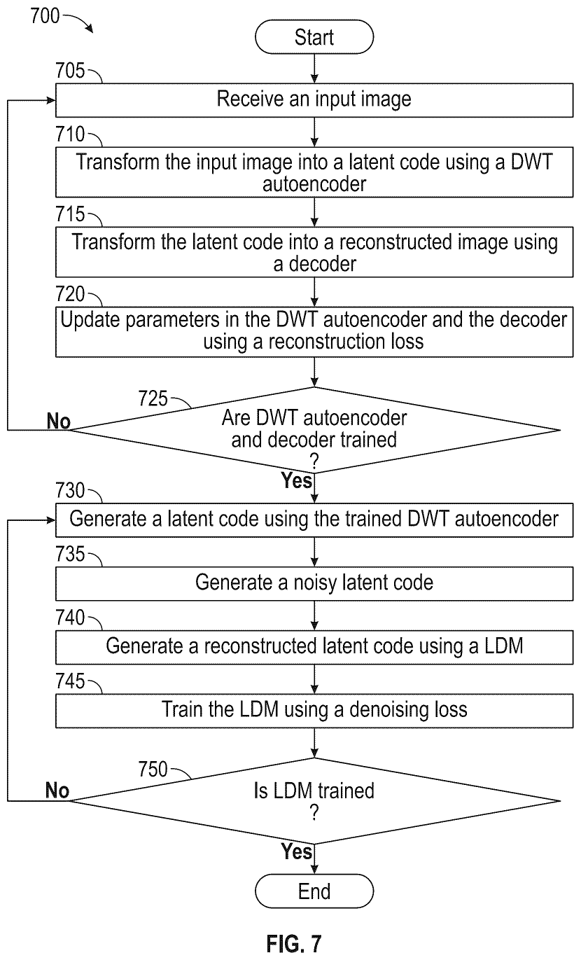

FIG. 7 is a flowchart of a method 700 for training a LDM using a DWT AE, according to one embodiment. At block 705, a training application receives an input image.

At block 710, an encoder of a DWT AE transforms the image into a latent code. In one embodiment, the DWT AE is a learned DWT AE that includes multiple feature extraction networks, such as neural networks. In one embodiment, the networks include CNNs. One example of a suitable network for feature extraction and aggregation is shown in FIG. 5.

In another embodiment, the DWT AE is a non-learned AE. That is, the AE does not include trainable neural networks.

In one embodiment, the encoder of the AE uses a multi-level DWT to preprocess the image. If the AE is a learned AE, the wavelet coefficients for each of the levels of the DWT can be fed into a separate feature extraction network. The outputs of the feature extraction networks can be aggregated to form the latent code. If the AE is a non-learned AE, the wavelet coefficients for the final level of the DWT can be used as the latent code.

At block 715, a decoder of the AE transforms the latent code into a reconstructed image.

At block 720, the training application updates parameters in the encoder and the decoder of the DWT AE using a reconstruction loss. The reconstruction loss can be derived from differences between the reconstructed image and the input image.

In one embodiment, the system can use two high-frequency reconstruction loss terms based on the wavelet transform and Gaussian blurring. Let x be the input image and x∧ the corresponding reconstruction. For the wavelet term, the training application computes the Charbonnier loss between the high frequency DWT sub-bands {x_{H}, x_{V}, x_{D}} and {\hat{x}_{LH}, \hat{x}_{HL}, \hat{x}_{HH}}. For the Gaussian loss, given a Gaussian filter h, the training application can compute the l₁ loss between x−h(x) and \hat{x}−h(\hat{x}).

At block 725, the training application determines whether the encoder and decoder of the AE are trained. For example, the training application may repeat the blocks 705-720 for every image in a training set. Further, the training application may repeat the training process with the training set multiple times or iterations.

One training strategy that can be used with the DWT AE is using downsampled versions of the images in a training set for X number of iterations and then using the full resolution versions of the images for Y number of iterations. For example, assuming the training application iterates through the training set of images 100 times, the training application may use downsampled version of the images for the first 75 iterations of the 100 iterations and then use the full resolution version of the images for the last 25 iterations.

Once trained, the method 700 switches to training the LDM. At block 730 the trained encoder of the DWT AE generates a latent code for an input image.

At block 735, the training application generates a noisy latent code by combining the latent code generated at block 730 with a noise sample (e.g., a random Gaussian noise sample).

At block 740, the LDM generates a reconstructed latent code from the noisy latent code.

At block 745, the training application updates parameters in the LDM using a denoising loss. This loss can be derived from comparing the reconstructed latent code to the latent code generated by the DWT AE.

At block 750, the training application determines whether the LDM is trained. For example, the training application may repeat the blocks 730-745 for every image in a training set. Further, the training application may repeat the training process with the training set multiple times or iterations. If trained, the method 700 ends.

While the embodiments above discuss an improved AE, the intermediate feature maps learned by the decoder can be relatively imbalanced, with certain areas having significantly stronger magnitudes. A modified version of modulated convolution instead of group normalization can be used to avoid imbalances. Instead of modulating the convolution layers via a data-dependent style vector, the convolution layer is allowed to learn the corresponding scales for each feature map. This operation can be referred to as a self-modulated convolution (SMC). SMC modifies the convolution weights wᵢⱼₖ according to:

$${w}_{ijk}^{′} = \frac{{s}_{i} {w}_{ijk}}{\sqrt{{\sum }_{i , k} {( {s}_{i} {w}_{ijk} )}^{2}} + ϵ}$$

For ∈>0, where sᵢ is a learnable parameter, and {i, j, k} spans the input feature maps, output feature maps, and the spatial dimension of the convolution. Using SMC in the decoder can balance the feature maps and also improve the final reconstruction quality due to better training dynamics.

The DWT AE described herein can also be used in an adversarial setup. the PatchGAN discriminator used in Stable Diffusion can be replaced with a UNet-based model for pixel-wise discrimination. The adaptive weight for the adversarial loss update may not provide any benefit and can be removed for more stable training, especially in mixed-precision setups.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language fsuch as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
transforming an input image into a latent code using an encoder of an autoencoder by performing a multi-level discrete wavelet transform (DWT) on the input image;
generating, based on the latent code, a reconstructed latent code using a latent diffusion model (LDM); and
training the LDM using a denoising loss based on comparing the reconstructed latent code and the latent code.

2. The method of claim 1, further comprising, before generating the reconstructed latent code:
generating a noisy latent code by combining the latent code with a noise sample, wherein the noisy latent code is input into the LDM.

3. The method of claim 1, wherein performing the multi-level DWT comprises:
performing DWT on the input image to generate first wavelet coefficients corresponding to a first plurality of sub-bands; and
performing DWT on one of the first plurality of sub-bands to generate second wavelet coefficients corresponding to a second plurality of sub-bands.

4. The method of claim 3, wherein the encoder is a learned encoder, the method comprising:
a first feature extraction network for extracting first features from the first wavelet coefficients; and
a second feature extraction network for extracting second features from the second wavelet coefficients.

5. The method of claim 4, further comprising:
aggregating the first and second features to generate the latent code.

6. The method of claim 5, further comprising:
downsampling the first features, but not the second features, before aggregating the first and second features.

7. The method of claim 4, further comprising, before training the LDM:
training the encoder comprising:
transforming a second input image into a second latent code using the encoder by performing the multi-level DWT on the second input image;
transforming the latent code into a reconstructed image using a decoder of the autoencoder; and
updating parameters in the encoder and the decoder using a reconstruction loss derived by from the reconstructed image and the second latent code.

8. The method of claim 3, wherein the encoder is a non-learned encoder, wherein the second wavelet coefficients are used as the latent code.

9. A non-transitory computer readable medium containing computer program code that, when executed by operation of one or more computer processors, performs operations comprising:
transforming an input image into a latent code using an encoder of an autoencoder by performing a multi-level discrete wavelet transform (DWT) on the input image;
generating, based on the latent code, a reconstructed latent code using a latent diffusion model (LDM); and
training the LDM using a denoising loss based on comparing the reconstructed latent code and the latent code.

10. The non-transitory computer readable medium of claim 9, wherein the operations further comprise, before generating the reconstructed latent code:
generating a noisy latent code by combining the latent code with a noise sample, wherein the noisy latent code is input into the LDM.

11. The non-transitory computer readable medium of claim 9, wherein performing the multi-level DWT comprises:
performing DWT on the input image to generate first wavelet coefficients corresponding to a first plurality of sub-bands; and
performing DWT on one of the first plurality of sub-bands to generate second wavelet coefficients corresponding to a second plurality of sub-bands.

12. The non-transitory computer readable medium of claim 11, wherein the encoder is a learned encoder, the operations comprising:
a first feature extraction network for extracting first features from the first wavelet coefficients; and
a second feature extraction network for extracting second features from the second wavelet coefficients.

13. The non-transitory computer readable medium of claim 12, wherein the operations further comprising:
aggregating the first and second features to generate the latent code.

14. The non-transitory computer readable medium of claim 13, wherein the operations further comprising, before training the LDM:
training the encoder comprising:
transforming a second input image into a second latent code using the encoder by performing the multi-level DWT on the second input image;
transforming the latent code into a reconstructed image using a decoder of the autoencoder; and
updating parameters in the encoder and the decoder using a reconstruction loss derived by from the reconstructed image and the second latent code.

15. The non-transitory computer readable medium of claim 11, wherein the encoder is a non-learned encoder, wherein the second wavelet coefficients are used as the latent code.

16. A system, comprising:
a processor; and
a memory having instructions stored thereon which, when executed on the processor, performs operations comprising:
transforming an input image into a latent code using an encoder of an autoencoder by performing a multi-level discrete wavelet transform (DWT) on the input image;
generating, based on the latent code, a reconstructed latent code using a latent diffusion model (LDM); and
training the LDM using a reconstruction loss based on comparing the reconstructed latent code and the latent code.

17. The system of claim 16, wherein performing the multi-level DWT comprises:
performing DWT on the input image to generate first wavelet coefficients corresponding to a first plurality of sub-bands; and
performing DWT on one of the first plurality of sub-bands to generate second wavelet coefficients corresponding to a second plurality of sub-bands.

18. The system of claim 17, wherein the encoder is a learned encoder, the operations comprising:
a first feature extraction network for extracting first features from the first wavelet coefficients; and
a second feature extraction network for extracting second features from the second wavelet coefficients.

19. The system of claim 18, wherein the operations further comprises, before training the LDM:
training the encoder comprising:
transforming a second input image into a second latent code using the encoder by performing the multi-level DWT on the second input image;
transforming the latent code into a reconstructed image using a decoder of the autoencoder; and
updating parameters in the encoder and the decoder using a reconstruction loss derived by from the reconstructed image and the second latent code.

20. The system of claim 17, wherein the encoder is a non-learned encoder, wherein the second wavelet coefficients are used as the latent code.
